(19) United States
(12) Patent Application Publication
(10) Pub. No.: US 2013/0262449 A1
(43) Pub. Date: Oct. 3, 2013

(54) SYSTEM AND METHOD FOR SEARCH REFINEMENT USING KNOWLEDGE MODEL

(71) Applicant: PLAYENCE GMBH, Innsbruck (AT)

(72) Inventors: Sinuhé Arroyo, Segovia (ES); José Manuel López Cobo, Segovia (ES); Guillermo Alvaro Rey, Segovia (ES); Silvestre Losada Alonso, Segovia (ES)

(73) Assignee: playence GmBH, Innsbruck (AT)

(21) Appl. No.: 13/855,563

(22) Filed: Apr. 2, 2013

Related U.S. Application Data
(60) Provisional application No. 61/619,375, filed on Apr. 2, 2012.

(51) Int. Cl. G06F 17/30

(52) U.S. Cl. CPC G06F 17/30442
USPC 707/722

(57) ABSTRACT

A system and method for information retrieval are presented. A first query is executed against a knowledge base using a natural language query to generate a result set. The knowledge base identifies a plurality of items, each associated with at least one annotation identifying at one of a plurality of entities in a knowledge model that defines a plurality of entities and interrelationships between one or more of the plurality of entities for a knowledge domain. The result set identifies a first set of items in the knowledge base. A graph of one or more of the entities in the knowledge model database is generated using a plurality of terms from the result set and the natural language query. A selection of one of the entities in the graph can be received from the client computer and used to restrict the number of items in the result set.

### CROSS-REFERENCE TO RELATED APPLICATIONS

This application claims priority to U.S. Provisional Patent Application 61/619,375 filed Apr. 2, 2012 and entitled “Ontology-Based Iterative Refinement Search Using Term-Selection.”

### FIELD OF THE INVENTION

The disclosure relates in general to an electronic system for querying a database and, more particularly, to a method and apparatus for enabling a user to iteratively refine results of a query executed against a database.

### BACKGROUND

In conventional information retrieval systems, most users follow a well-known pattern consisting of two steps: First, there is an initial query, either expressed in natural language or via keywords, used to search a database for a wide range of results; second there is a filtering and selection step that is executed to obtain just a relevant subset of the initial results. This may involve the user, for example, sorting the results by chronological ordering, adding keywords to limit the number of results, and the like.

There exist different approaches and algorithms with respect to the first of those two steps, which help retrieve an initial set of results that match the user query. In particular, ontology-powered approaches and semantic technologies have enabled more precise results in this first step, for they enable a better “understanding” of the user needs. However, with respect to the second step within this search schema, namely the filtering and selection of information, the use of ontologies has not been explored.

The filtering and selection of results is particularly relevant in systems with a high volume of information in which users retrieve too many results, making the relevant documents not easily accessible.

### BRIEF SUMMARY

The disclosure relates in general to an electronic system for querying a database and, more particularly, to a method and apparatus for enabling a user to iteratively refine results of a query executed against a database.

In one implementation, the present invention is an information retrieval system comprising a knowledge model database configured to store a knowledge model for a knowledge domain. The knowledge model defines a plurality of entities and interrelationships between one or more of the plurality of entities. The system includes a knowledge base identifying a plurality of items. Each of the plurality of items is associated with at least one annotation identifying at one of the entities in the knowledge model. The system includes a query processing server configured to receive a natural language query from a client computer using a computer network, and execute a first query against the knowledge base using the natural language query to generate a first set of results. The first set of results identifies a first set of items in the knowledge base. The query processing server is configured to analyze the first set of results and the natural language query to identify a plurality of terms, generate a graph of one or more of the entities in the knowledge model database using the plurality of terms, and transmit the graph to the client computer. The query processing server is configured to receive, from the client computer, a selection of at least one of the entities in the graph, and execute a second query against the knowledge base using the natural language query and the selected at least one of the entities in the graph to generate a second set of results. The second set of results identifies a second set of items in the knowledge base. The query processing server is configured to transmit the second set of results to the client computer.

In another implementation, the present invention is a method for information retrieval. The method includes receiving, from a client computer, a natural language query using a computer network, and executing a first query against a knowledge base using the natural language query to generate a first set of results. The knowledge base identifies a plurality of items. Each of the plurality of items is associated with at least one annotation identifying at one of a plurality of entities in a knowledge model. The knowledge model defines a plurality of entities and interrelationships between one or more of the plurality of entities for a knowledge domain. The first set of results identifies a first set of items in the knowledge base. The method includes analyzing the first set of results and the natural language query to identify a plurality of terms, generating a graph of one or more of the entities in the knowledge model database using the plurality of terms, transmitting the graph to the client computer, and receiving, from the client computer, a selection of at least one of the entities in the graph. The method includes executing a second query against the knowledge base using the natural language query and the selected at least one of the entities in the graph to generate a second set of results, the second set of results identifying a second set of items in the knowledge base, and transmitting the second set of results to the client computer.

In another implementation, the present invention is a non-transitory computer-readable medium containing instructions that, when executed by a processor, cause the processor to perform the steps of receiving, from a client computer, a natural language query using a computer network, and executing a first query against a knowledge base using the natural language query to generate a first set of results. The knowledge base identifies a plurality of items. Each of the plurality of items is associated with at least one annotation identifying at one of a plurality of entities in a knowledge model. The knowledge model defines a plurality of entities and interrelationships between one or more of the plurality of entities for a knowledge domain. The first set of results identifies a first set of items in the knowledge base. The instructions cause the processor to also perform the steps of analyzing the first set of results and the natural language query to identify a plurality of terms, generating a graph of one or more of the entities in the knowledge model database using the plurality of terms, transmitting the graph to the client computer, and receiving, from the client computer, a selection of at least one of the entities in the graph. The instructions cause the processor to also perform the steps of executing a second query against the knowledge base using the natural language query and the selected at least one of the entities in the graph to generate a second set of results, the second set of results identifying a second set of items in the knowledge base, and transmitting the second set of results to the client computer.

### BRIEF DESCRIPTION OF THE DRAWINGS

FIG. 1 is a block diagram illustrating one example configuration of the functional components of the present information retrieval system.

FIG. 2 is a block diagram showing functional components of a query generation and processing system.

FIG. 3 is a flowchart illustrating an exemplary method for performing a query in accordance with the present disclosure.

FIG. 4 is a flowchart illustrating an exemplary method for performing a query in accordance with the present disclosure that enables a user to refine the search results.

FIG. 5 depicts an example of a graph that may be displayed for the user along with the set of results in response to a natural language query.

FIG. 6 depicts an example graph that may be transmitted to the user in response to the natural language query “Interviews with Marlon Brando about The Godfather”.

FIG. 7 is a depiction of a second example graph that may be transmitted to the user in response to the natural language query where the user has selected a term to refine the search.

FIG. 8 is an illustration showing the overlap between sets of terms.

FIG. 9 is a portion of screenshot showing an example user interface after the execution of an initial query where no additional restriction terms have been selected.

FIG. 10 is a portion of screenshot showing an example user interface after the execution of an initial query where one or more restriction terms have been selected.

### DETAILED DESCRIPTION OF THE DRAWINGS

The disclosure relates in general to an electronic system for querying a database and, more particularly, to a method and apparatus for enabling a user to iteratively refine results of a query executed against a database.

This invention is described in embodiments in the following description with reference to the Figures, in which like numbers represent the same or similar elements. Reference throughout this specification to “one embodiment,” “an embodiment,” “one implementation,” “an implementation,” or similar language means that a particular feature, structure, or characteristic described in connection with the embodiment is included in at least one embodiment of the present invention. Thus, appearances of the phrases “in one implementation,” “in an implementation,” and similar language throughout this specification may, but do not necessarily, all refer to the same embodiment.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present disclosure provides a system and method providing a two-step search algorithm that enables a user to initiate a search using, for example, a natural language query, and then, after the search has been executed, perform an iterative refinement of the search results using filtering and selection, where the filtering and selection is powered by an underlying ontology model.

For a given subject matter, the present system provides both a knowledge model and a knowledge base. The knowledge model includes an ontology that defines concepts, entities, and interrelationships thereof for a given subject matter or knowledge domain. The knowledge model, therefore, normalizes the relevant terminology for a given subject matter domain.

The knowledge model may be composed of different ontological components that define the knowledge domain: Concepts (Classes), which are abstract objects of a given domain (in the present disclosure the knowledge domain of “the cinema” may be used for a number of non-limiting examples) such as categories or types; an example of a concept would be “actor”, “director” or “movie”; Instances (Individual objects), which are concrete objects, for example a given actor such as “Marlon Brando” or a movie like “The Godfather”; Relationships (relations), which specify how objects in an ontology relate to other objects, for example the relationship “appears in” links the concept “actor” with the concept “movie”, and so does with the concrete instance “Marlon Brando” with the instance “The Godfather”.

The knowledge base, in contrast, is the store of information that the information retrieval system is configured to search. The knowledge base is a database including many items (or references to many items) where the items can include many different types of content (e.g., documents, data, multimedia, and the like) that a user may wish to search. The content of the knowledge base can be stored in any suitable database configured to store the contents of the items and enable retrieval of the same. To facilitate searching, the items in the knowledge base can each be associated with different concepts or entities contained within the knowledge base. This association can be made explicitly (e.g., through the use of metadata associated with the content), or implicitly by the item's contents. With the knowledge base catalogued in accordance with the knowledge model, the knowledge model becomes an index or table contents of contents by which to navigate the contents of the knowledge base.

To facilitate the filtering of search results retrieved from the knowledge base, the present system utilizes the knowledge embodied within the relevant knowledge model. The knowledge model uses ontologies, described in more detail below, which help contextualize the items to be retrieved from the knowledge base depending on terms of the knowledge model that appear in or are associated to them. In the present system, the ontologies may be depicted in the form of a visual graph, enabling a user to easily navigate through the terms and relationships of the ontology. By browsing through the ontological model and selecting certain elements thereof, the set of results presented to the user can be filtered according to the annotations of documents to be retrieved from the knowledge base. This enables the user to more easily locate the desired information. Additionally, the navigation across the different terms of the structured knowledge model allows users to find and use more relevant terms within particular knowledge domain.

In the present system, to facilitate the user navigating the knowledge model (or ontology), the user is presented with a visual representation or graph of the knowledge model's contents. The knowledge model graphs sets out, in a two-dimensional space, a number of entities or concepts contained within the knowledge model. The entities or concepts are then interrelated by a number of visual indicators (e.g., a solid line, dashed line, or colored line) that indicate the type of relationship that two or more of the entities or concepts may have. Each node of the graph, therefore, can indicate an entity or concept selected from the knowledge model. In this disclosure the “graph structure” is to be understood in a broad sense as a visual representation of a set of entities that may each be interrelated through formal relationships.

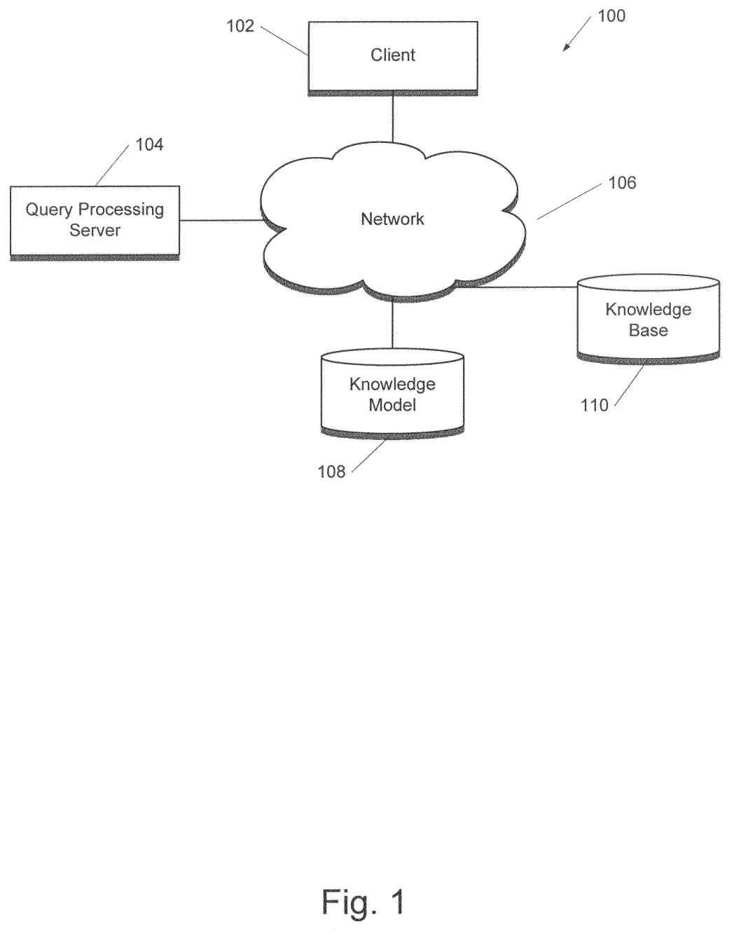

FIG. 1 is a block diagram illustrating one example configuration of the functional components of the present information retrieval system 100. System 100 includes client 102. Client 102 includes a computer executing software configured to interact with query generation and processing server 104 via communications network 106. Client 102 can include a conventional desktop computer or portable devices, such as laptops computers, smartphones, tablets, and the like. A user uses client 102 to refine the results of a query by manipulating a node-based graph that depicts the entities of a knowledge model and their interrelationships. The user can use client 102 to select one or more entities from the knowledge model to filter and/or select items from the result set. After a search is created and executed and, potentially, filtered in accordance with the present disclosure, client 102 displays the search results for review by the user.

Query generation and processing server 104 is configured to interact with client 102 to perform a query. In one implementation, the query is a natural language query, where a user supplies the natural language query terms using client 102. Query processing server 104 is also configured to transmit to client 102 a graph depicting a knowledge model. The user can then select one or more entities from the knowledge model to further filter the search results. Although in FIG. 1 these two functions are depicted as being executed by the same device, the two functions could be distributed across a number of different devices.

To depict the knowledge model for the user and to allow manipulation of the same, query generation and processing server 104 accesses knowledge model database 108, which contains the knowledge model (i.e., the concepts, instances and relationships that define the subject matter domain). Once a query has been created, query generation and processing server 104 executes the query against knowledge base database 110, which stores the knowledge base and any metadata describing the items of the knowledge base. In knowledge base database 110, the items to be retrieved are generally annotated with one or more of the terms available in the knowledge model.

In the present disclosure, when describing the knowledge model, or the underlying ontology of the knowledge model, the following naming conventions may be used. However, other knowledge model structures may be utilized through similar models employing a graphical structure that relates entities of an ontology through formal relationships, but with different naming conventions.

The present knowledge model is composed of different ontological components.

“Concepts” (e.g., classes) are abstract objects of a given knowledge domain such as categories or types. An example of a concept would be “actor”, “director” or “movie” for a knowledge domain involving cinema.

“Instances” (e.g., individual objects) are concrete objects in the given knowledge domain. Examples include a given actor such as “Marlon Brando” or a movie like “The Godfather”.

“Entities” refer to both Concepts and Instances, i.e., the nodes in the knowledge graph.

“Relationships” (e.g., relations) specify how objects in the knowledge model relate to other objects. For example, the relationship “appears in” links the concept “actor” with the concept “movie.” Relationships can also relate instances. For example, the relationship “appears in” relates instance “Marlon Brando” with the instance “The Godfather”.

A knowledge model may be constructed by hand, where engineers (referred to as ontology engineers) lay out the model's concepts, instances and relationships and the relationships thereof. This modeling is a process where domain-specific decisions need to be taken, and even though there exist standard vocabularies and ontologies, it is worth noting the same domain may be modeled in different ways, and that such knowledge models may evolve over time. Sometimes the semantic model is used as a base and the model's individual components are considered static, but the present system may also be implemented in conjunction with dynamic systems where the knowledge model varies over time.

As mentioned above, the present system uses two well-differentiated data repositories; the knowledge model and the knowledge base.

The knowledge model repository (stored, for example, in knowledge model database 108) contains the relationships amongst the different types of entities in the knowledge domain. The knowledge model identifies both the “schema” of abstract concepts and their relationships, such as the concepts “actor” and “movie” connected through the “appears in” relationship, as well as concrete instances with their respective general assertions in the domain, such as concrete actors like “Marlon Brando” or directors like “Francis Ford Coppola”, and their relationship to the movies they appear on, or have directed, etc.

One possible implementation of the knowledge model, considering the particular example of semantic (ontological) systems could be a “triplestore”—a repository (database) purposefully built for the storage and retrieval of semantic data in the form of “triples” (or “statements” or “assertions”). “Triples” are data entities that follow a subject-predicate-object (s, p, o) pattern, where the subject and object are entities of the semantic model, and the predicate is a relationship. An example of such a triple is (“Marlon Brando”, “appears in”, “The Godfather”). A semantic data model widely extended for expressing these statements is the Resource Description Framework (RDF). Query languages like SPARQL can be used to retrieve and manipulate RDF data stored in triplestores.

The knowledge model thus contains the relationships amongst the different types of resources in the application domain. The knowledge model contains both the ontological schema of abstract concepts and their relations, such as (“actor”, “appears in”, “movie”), as well as instances with their respective general “static” assertions valid for the whole domain, such as concrete actors like “Marlon Brando” or directors like “Francis Ford Coppola”, and their relationship to the movies they appear on, or have directed, etc.

It is worth noting that the triplestore arrangement is just a possible implementation of a knowledge model, in the case that a semantic model is used. However, other types of repositories able to define the entities and relationships of the knowledge model may also be used.

The knowledge base is the repository that contains the items or content that the user wishes to search and retrieve. The knowledge base may store many items including many different types of digital data. The knowledge base, for example, may store plain text documents, marked up text, multimedia, such as video, images and audio, programs or executable files, raw data files, etc. The items can be annotated with both abstract concepts (e.g., “actor”) and particular instances (e.g., “Marlon Brando”) selected from the knowledge model, which are particularly relevant for the given item. One possible implementation of the knowledge base is a Document Management System that permits the retrieval of documents via an index of the entities of the knowledge base. To that end, documents in the repository need to be associated to (or “annotated with”) those entities.

The techniques described herein can be applied to repositories of documents in which annotations have been performed through different manners. The process of annotation for the documents may have been performed both manually, with users associating particular concepts and instances to the document to particular entities in the knowledge model, and/or automatically, by detecting which references to entities appear in each knowledge base item. Systems may provide support for manual annotations by facilitating the user finding and selecting entities from the knowledge model, so these can be associated to items in the knowledge base. For example, in a possible embodiment, the system may offer auto-complete functionality so when the user begins writing “Marlon”, the system might suggest “Marlon Brando” as a particular instance that the user could choose. The user may decide then to annotate a given item with the chosen instance, i.e., to specify that the entity from the knowledge model is associated to the particular item in the knowledge base.

When automatically creating metadata for the knowledge base items, techniques like text parsing and speech-to-text over the audio track or a multimedia item can be used along with image processing for videos. In this manner, it is possible to associate each of the items in the knowledge base (or even portions of the items), with the entities in the domain knowledge. This process is dependant on the knowledge model because the identification of entities in the knowledge base item is performed in reliance upon the knowledge model. For example, the visual output of certain documents (e.g., images or video) can be analyzed using optical character recognition techniques to identify words or phrases that appear to be particularly relevant to the document. These words or phrases may be those that appear often or certain words or phrases that may appear in a corresponding knowledge base. For example, when operating in the theatre knowledge domain, when a document includes words or phrases that match particular concepts, instances, relationships, or entities within the knowledge domain (e.g., the document includes the words “actor”, “Al Pacino”, and “Marlon Brando”) the document can be annotated using those terms. For documents containing audio, the audio output can be analyzed using speech to text recognition techniques to identify words or phrases that appear to be particularly relevant to the document. These words or phrases may be those that are articulated often or certain words or phrases that may appear in a corresponding knowledge base. For example, when operating in the theatre knowledge domain, when a document includes people discussing particular concepts, instances, relationships, or entities within the knowledge domain the document can be annotated using those terms.

Additionally, a combination of approaches (semi-automatic techniques) is also possible for annotating the knowledge base. The result of such annotation techniques is that the documents in the knowledge base repository are then indexed with metadata according to the entities (knowledge model concepts and/or instances) that appear in or have been associated to the items.

In the case of manual annotation, terms that belong to the knowledge model are associated with the items in the knowledge base. Different techniques for encouraging users to participate in the manual annotation of content may be applied, like the use of Games with a Purpose to leverage the user's interactions while they play. Again, the underlying knowledge model and the model's design define the kinds of annotations that can be applied to the items in the knowledge base.

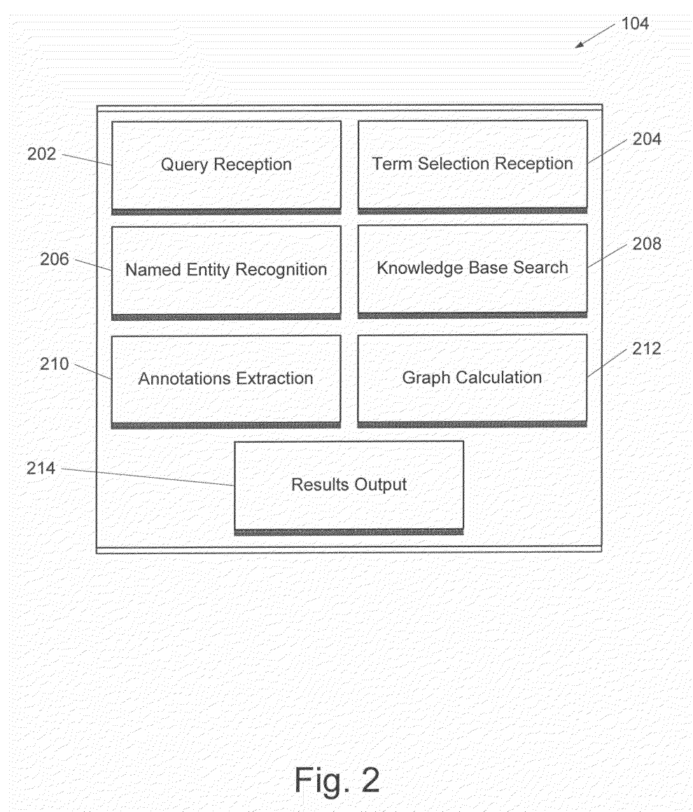

FIG. 2 is a block diagram showing the functional components of query generation and processing server 104. Query generation and processing server 104 includes a number of modules configured to provide one or more functions associated with the present information retrieval system. Each module may be executed by the same device (e.g., computer or computer server), or may be distributed across a number of devices.

Query reception module 202 is configured to receive a natural language query targeted at a particular knowledge base. The query may be received, for example, from client 102 of FIG. 1. In various other implementations of query generation and processing server 104, though, other types of queries may be received and processed, such as natural language queries, keyword queries, and the like.

Term selection reception module 204 is configured to receive the selection of nodes or entities of the knowledge model by the user on the client 102, and/or the user performing a particular action on a node (e.g., expanding the node to continue navigation, or selecting a particular node for filtering search results).

Named entity recognition module 206 is configured to locate, within unstructured text, atomic elements that belong to a predefined set of categories, such as the names of persons, organizations, locations, etc. (sometimes referred to as “entity identification” or “entity extraction”). For example, if named entity recognition is performed on a sentence such as “M. Brando answering questions about The Godfather movie”, at least the named entities for “Marlon Brando” and “The Godfather” (note that in the former case, even though the name is not exactly identical, because of the use of synonyms in the knowledge model) would be identified.

Knowledge base search module 208 uses the query processed through query reception module 202 to retrieve items from the knowledge base (or links thereto) that are relevant to (i.e., that satisfy the requirements of) the query. After an initial set of results has been provided to the user, the knowledge base search module 208 is configured to utilize both the natural language query and a selection of ontological terms (in this case, through the choices taken by the user) for retrieving documents in the knowledge base that are relevant for the words contained in the query and the specified terms.

Annotations extraction module 210 is configured to, for a set of search results identifying items in the knowledge base, retrieve the ontological terms related to those documents. Accordingly, after a natural language query has been executed, generating a set of search results, annotations extraction module 210 is configured to analyze the documents associated with those search results to identify terms (e.g., entities) from the relevant knowledge model that appear in those documents.

Graph calculation module 212 is configured to generate a node-based graph depicting a number of entities from the knowledge model and their interrelationships. The node-based graph can then be presented to the user via a client computer (e.g., client 102 of FIG. 1). The users can interact with the graph by selecting particular entities for inclusion within a query, or by navigating through the knowledge model by manipulating the graph.

In the present system, graph calculation module 212 is configured to, after a set of search results have been presented to the user, generate a node-based graph depicting terms that are relevant to search results. The user can then select one or more of the depicted terms causing the set of search results to be filtered. The relevant terms included within the graph may include those of the original natural language query, as well as those already selected by the user. The graph may also include terms that are directly related with the previous ones and at the same time appear in the set of terms as output of the annotations extraction.

Results output module 214 is configured to retrieve the items (or links thereto) that are relevant to an executed query and provide an appropriate output to the user on client 102. In addition to the items themselves, results output module 214 may be configured to generate statistics or metrics associated with the resulting items and depict that data to the user. Results output module 214 may also depict a graph showing the relevant knowledge model entities that are present in the search results, such as the graph generated by graph calculation module 212.

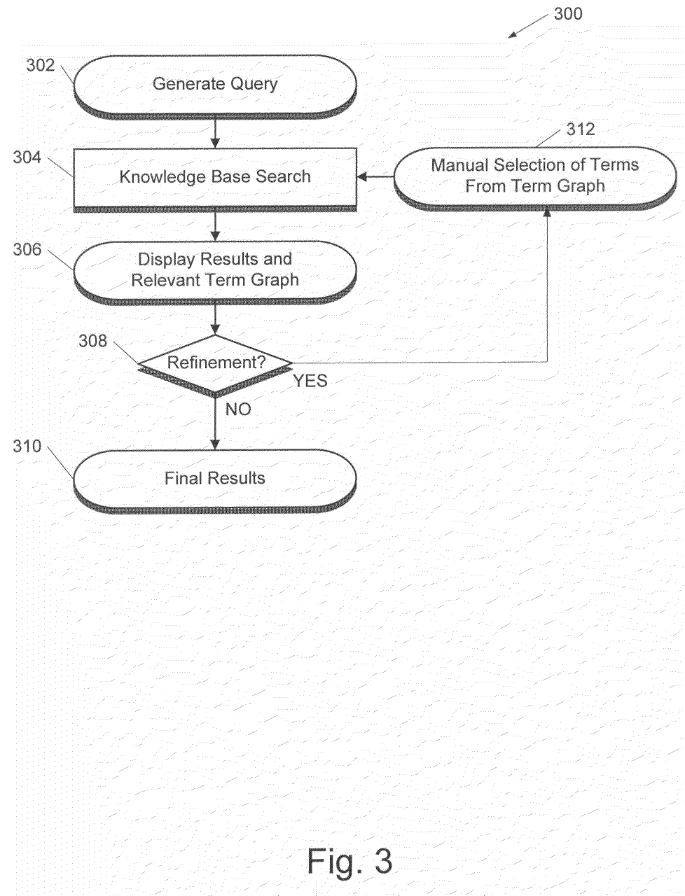

FIG. 3 is a flowchart illustrating a high-level method 300 for performing a query and refining a corresponding result set in accordance with the present disclosure. In step 302 a query is generated. The query may be a natural language query (as presented in a number of examples of the present disclosure) or may involve other types of queries including structured language queries, key word queries, and combinations thereof.

After the query is generated, in step 304 the query is executed against the knowledge base database. After the query is executed, the results (including, for, example, a listing of items from the knowledge base that satisfy the query) are depicted for the user in step 306. Step 306 also includes displaying along with the results a node-based graph depicting terms that are relevant to search results, where the terms may be selected from a relevant knowledge model, the query terms, or combinations thereof.

In step 308 the user determines whether the search results are satisfactory and whether those results should be further refined. If not, in step 310, the final result set, based upon the search query of step 302, are displayed as final results.

If, however, the user wishes to further refine the result set, in step 312 the user may navigate through the graph of relevant terms displayed in step 306 and select one or more of those terms to refine the search results. If such a selection is made, the selected terms are combined with the original search query and the knowledge base is again searched using the combined search query. After executing the refined query a new result set and related graph are displayed in step 306 and the process continues.

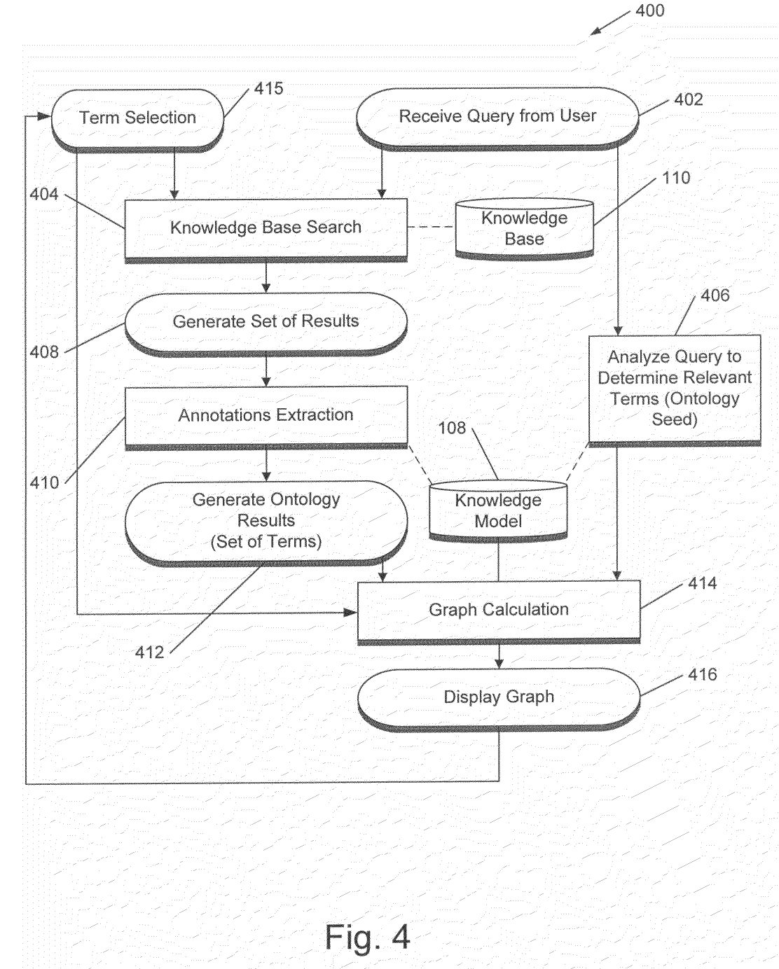

FIG. 4 is a flowchart illustrating method 400 for executing a query received from a user in accordance with the present disclosure and then refining the results of the query. FIG. 4 covers both the execution of a new query, as well as the consideration of refinements of the result set through term selection.

In step 402, an initial query (e.g., a natural language query) is received from the user. This may take the form, for example, of a sentence in free text.

After receiving the initial query, in step 404 the query is executed against the knowledge base 110. At this point, the user has not made any additional term selections (described below), so the knowledge base search of step 404 is only executed using the natural language query provided by the user in step 402. An example natural language query that may be received in conjunction with the initial execution of step 402 may be “Interviews with Marlon Brando about The Godfather”. In such an example, the query belongs to the cinema domain and, as such, the relevant ontology or knowledge model will be one suitable for use in such a domain.

The query received in step 402 is also analyzed in step 406 using named entity recognition to identify a set of terms from the relevant ontology or knowledge model that are relevant to the natural language query. This set of relevant terms become an “ontology seed”, which is a set of terms from the relevant ontology that will act as base for the browsing of the ontology graph during query refinement. In the present example, where the query is “Interviews with Marlon Brando about The Godfather”, the analysis of the query performed in step 406 may identify the concepts “Marlon Brando” (actor) and “The Godfather” (movie).

After executing the search in step 404, a set of results is generated in step 408. The search results can be transmitted back to the requesting user for review.

In the present cinema example, if the natural language query “Interviews with Marlon Brando about The Godfather” were to be executed against a particular knowledge base, such a search may generate a very large number of results containing a high number of documents that are relevant for the query and the two concepts identified in it, i.e., interviews with Marlon Brando and potentially other people addressing The Godfather and potentially many other movies.

The set of results generated in step 408 is composed of a number of documents that have annotations. The annotations relate the documents in the result set with ontological terms present in the knowledge model 108 for that domain (in the present example, the domain is the cinema domain). In step 410, the set of results is processed to obtain ontological terms that are present in both the knowledge model and the documents of the result set. The outcome of this process generated in step 412 is a set of terms from the ontology (“ontology results”). In one implementation, each document or item in the result set may be analyzed to identify terms therein that also appear in the relevant knowledge model. This analysis may be performed by named entity recognition, enabling the system to look for the relevant entities in the knowledge domain.

In the present example, once the query for “Interviews with Marlon Brando about The Godfather” is executed, the documents in the result set may be analyzed to generate ontology results. In this example, the ontology results could include additional people and movies that are related to the retrieved documents. The ontology results may include, for example, “Francis Ford Coppola”, “Robert Duvall”, “Apocalypse Now”, “A Streetcar Named Desire”, etc.

In step 414, both sets of terms generated in steps 412 and 406 are combined and used to perform graph calculation. Specifically, the two sets of terms include the ontology terms derived by analyzing the set of results generated by the user's query for terms that are present within the relevant knowledge model, as well as the relevant terms derived by analyzing the user's query for terms that are present within the relevant knowledge model. Both sets of terms are used for performing graph calculation, a step in which both sets of terms are combined in order to create a node-based graph that includes the terms identified in the query along with those that are directly related to them in the knowledge model, and at the same time appear in the set of terms resulting from processing the set of results. More details about the graph calculation are given below.

The graph generated in step 414 is transmitted to the client in step 416. The client then displays the graph and the user is provided with an opportunity to select one or more items from the graph. The selected terms can then be used to refine the search results.

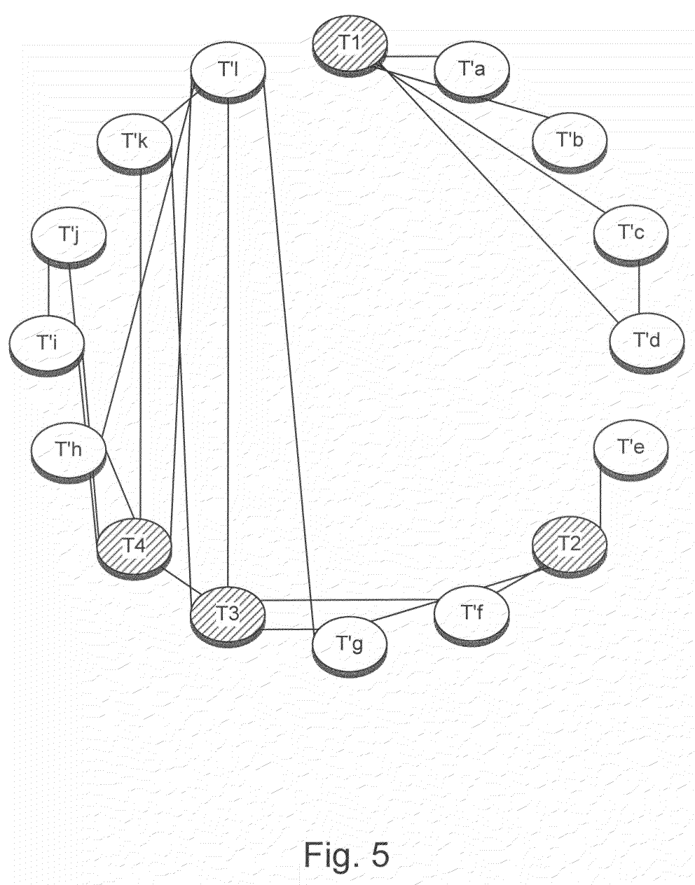

FIG. 5 depicts an example of a graph that may be displayed for the user along with the set of results in response to a natural language query. The graph of FIG. 5 depicts different types of nodes, including nodes obtained from the user query, or already selected by the user, and nodes that show up in the set of results, which are directly connected (at a “distance 1”) with the other nodes.

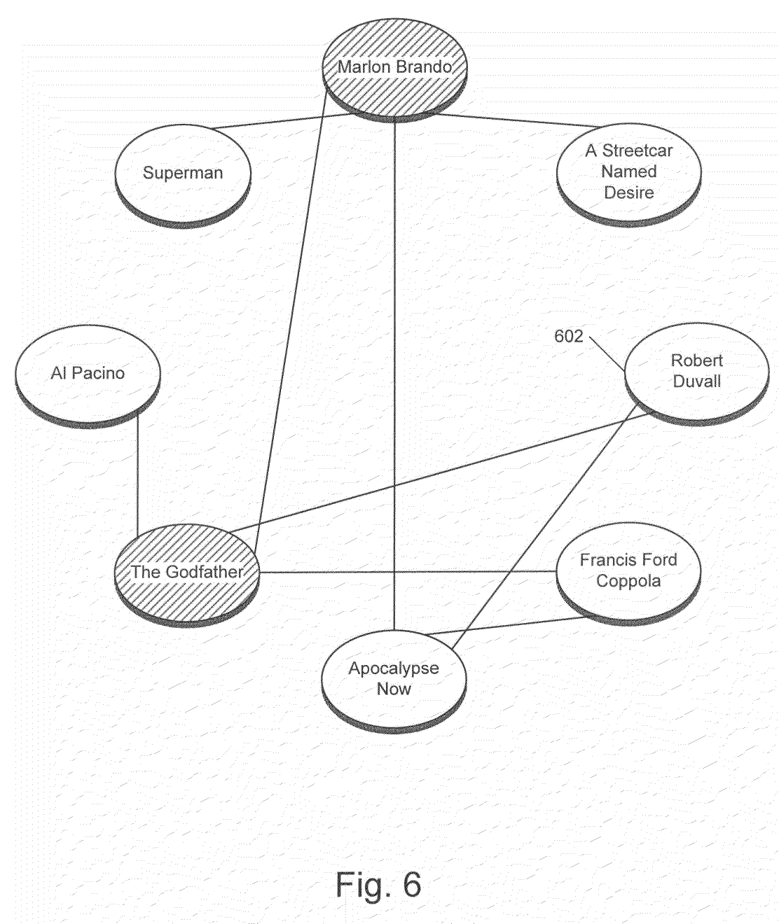

For the present example, FIG. 6 depicts an example graph that may be transmitted to the user in response to the natural language query “Interviews with Marlon Brando about The Godfather”. As shown in FIG. 6, the graph includes nodes of terms found in the natural language query (i.e., “Marlon Brando” and “The Godfather”) and terms in the domain model that are directly connected to those term (e.g., by a distance 1) and also that show up in the result set of documents (the rest of movies, actors and directors in the graph).

Having displayed the graph for the user, the user may wish to select one or more of the items from the graph to further restrict the result set. Accordingly, referring to FIG. 4, when the user selects a term in the displayed graph (see step 415), the search process is executed again, but with the selected term (or terms) from the graph as an additional entry to the knowledge base search in step 404. Accordingly, the terms selected in the displayed graph are used in the semantic query (for example, the selected terms may be ANDED with the terms in the natural language query), enforcing the results to be annotated with the selected terms, therefore restricting the number of results. In one implementation, the natural language query is ANDED with the selected terms to add a constraint to the query. As such, the subsequent search results, in addition to satisfy the requirements of the original query, must also include the selected term or terms.

Returning to FIG. 6, in the present cinema example, assume that node 602 corresponding to the actor “Robert Duvall” was selected. When the search was re-executed using this additional term, the set of results would be highly reduced, for the result set would now only include items that are also related to that particular instance (i.e., Robert Duvall), too. In the example, these could include documents containing interviews featuring Marlon Brando, Robert Duvall, and The Godfather movie.

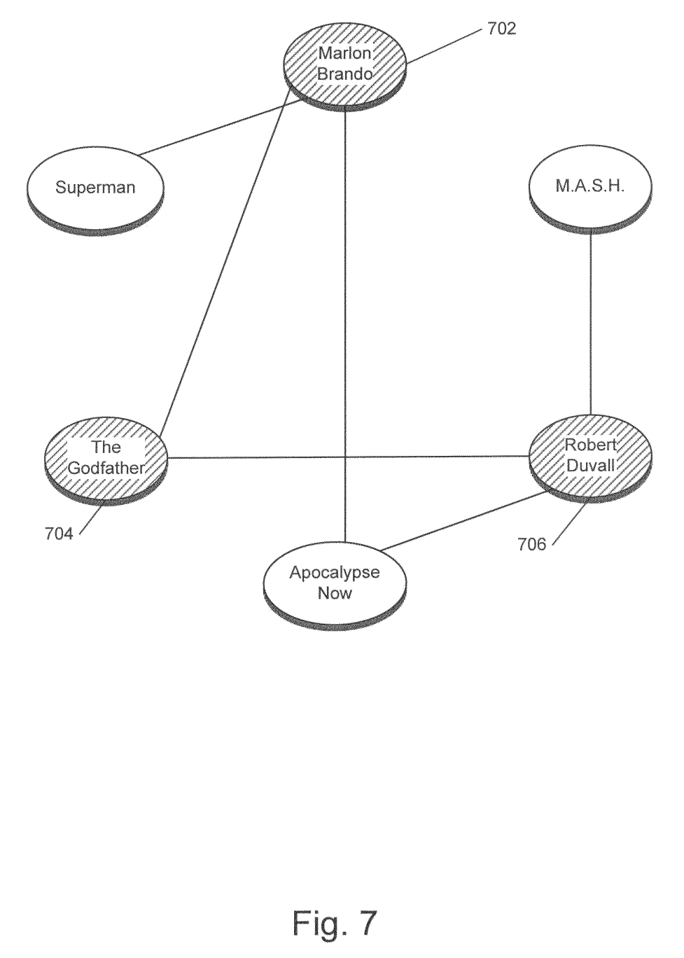

After re-executing the search with this additional term, the graph returned to the user (e.g., in step 416 of FIG. 4) would be updated based upon the refined result set. FIG. 7 shows the graph after the additional term (e.g., Robert Duval) is introduced. In FIG. 7, terms 702 and 704 are terms retrieved from the natural language query (e.g., retrieved in step 406 of FIG. 4) and term 706 is the term selected by the user, namely “Marlon Brando”, “The Godfather” and “Robert Duvall”; the other type of terms in the graph of FIG. 7 (present in the results and at a distance 1 with the other terms) could include new instances, like “M.A.S.H.” in the example, while at the same time some terms which were present in the set of results before, might not show up now because they are no longer in that set after the filtering (e.g., “Al Pacino”).

It is worth noting that the selection of terms is also used in the calculation of the graph, to further refine also the terms that show up in the graph, helping the user.

Accordingly, as shown in FIG. 4, there are three different sets of terms that are utilized for graph calculation. These sets include:
T_{q}: Set of terms extracted from the user query. This set is the “ontology seed” that drives the refinement iterations.
T_{q}: Set of terms selected by the user from the display knowledge model graph. This set of terms is not available upon the first iteration of the method of FIG. 4, when only the natural language query is executed, however this set of terms becomes at the iterative refinement phase, and includes the terms that have been explicitly selected by the user in the client interface from the depicted graph.
Tᵣ: Set of terms available in the set of results. The “ontology results” set is composed by the terms used to annotate the documents returned by the knowledge base search process.

For the graph calculation (e.g., step 414 of FIG. 4), a fourth set of terms is calculated using T_{q}, T_{q}, and Tᵣ: T_{d:} Set of terms at “distance 1” with respect to T_{q} and Tₛ. This is the set of terms which have a direct relationship in the domain knowledge model with the terms in the query (T_{q}) and those that have been selected by the user (Tₛ).

For the present cinema example, after the selection of the term “Robert Duvall” during the refinement stage, the four sets of terms would be:

T_{q}: {“Marlon Brando”, “The Godfather”}

Tₛ: {“Robert Duvall”}

Tᵣ: {“Marlon Brando”, “The Godfather”, “Robert Duvall”, “Apocalypse Now”, “Superman”, “M.A.S.H.”, “Charlie Chaplin”, “Pulp Fiction”, . . . } (incomplete list)

T_{d}: {“Apocalypse Now”, “Superman”, “A Streetcar Named Desire”, “Al Pacino”, “Robert de Niro”, “Francis Ford Coppola”, “M.A.S.H.”, . . . } (incomplete list)

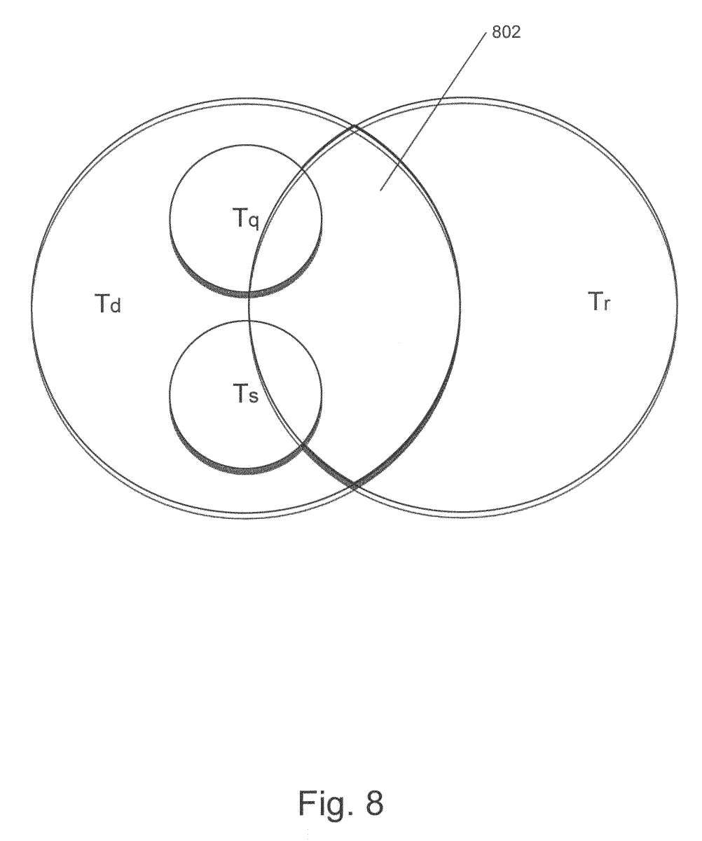

FIG. 8 is an illustration showing the overlap between sets of terms. In FIG. 8, it is shown that T_{d} is a set that covers T_{q} and Tₛ, and that there is a potential overlap between Tᵣ and each of those three. The diagram also highlights which terms are to be part of the calculated graph. As explained above, the graph is composed of two types of nodes:

“Core nodes” are either obtained from the user query (the “ontology seed” T_{q}) or are already selected by the user (Tₛ). This resulting set of terms is represented by the union of T_{q} and Tₛ: {T_{q}∪Tₛ}.

“Related nodes” show up in the set of results (Tᵣ) and are directly connected (at a “distance 1”) with the “core nodes” (T_{d}). This resulting set of terms is find in the region labeled 802, and can be represented as {(Tᵣ∩T_{d})−(T_{q}∪Tₛ)}, meaning that it is the intersection of Tᵣ and T_{d}, but the core nodes {T_{q}∪Tₛ} are not to be included.

The calculated set of terms (nodes to be included in the graph, both “core” and “related” types) are put together along with the relationships from the domain knowledge that link them, forming a graph, such as the graph illustrated in FIG. 5, where nodes T1-T4 are “core” terms, and nodes T′a-T′l are “related” ones. This kind of graph could be formally represented as {coreNodes={T1, T2, . . . T4}, relatedNodes={T′a, T′b, . . . T′l}, relations={(T1,T′a), (T1,T′b), . . . (T′k,T′l)}}, with information about the two types of nodes and all the relations amongst them.

From such a graph, the user is able to select one of the related terms (the second type of node; T′a-T′l in the example), triggering the search process again with the same “ontology seed” T_{q}, but a different set of related terms Tₛ, and thus potentially with a different set of terms at a “distance 1” T_{d}. This new combination of set of terms implies that the set of results (documents found) will also vary, hence providing a different set of terms from the annotations TᵣTherefore, the graph calculated for each new iteration will vary, allowing users to keep refining and filtering the results through new selections, until they are satisfied with the set of results.

In the present example, as depicted in FIG. 7, the “core nodes” are thus {“Marlon Brando”, “The Godfather”, “Robert Duvall”}, and the “related nodes” are {“Apocalypse Now”, “Superman”, “M.A.S.H.”}, because they both show up in the results of the search and are at a distance 1 of the core nodes in the domain model. Other instances of actors and movies do not appear in the graph as related because either they are not associated to the results of the search (e.g., “Robert de Niro”) or they are not directly related to the core node (e.g., “Pulp Fiction”).

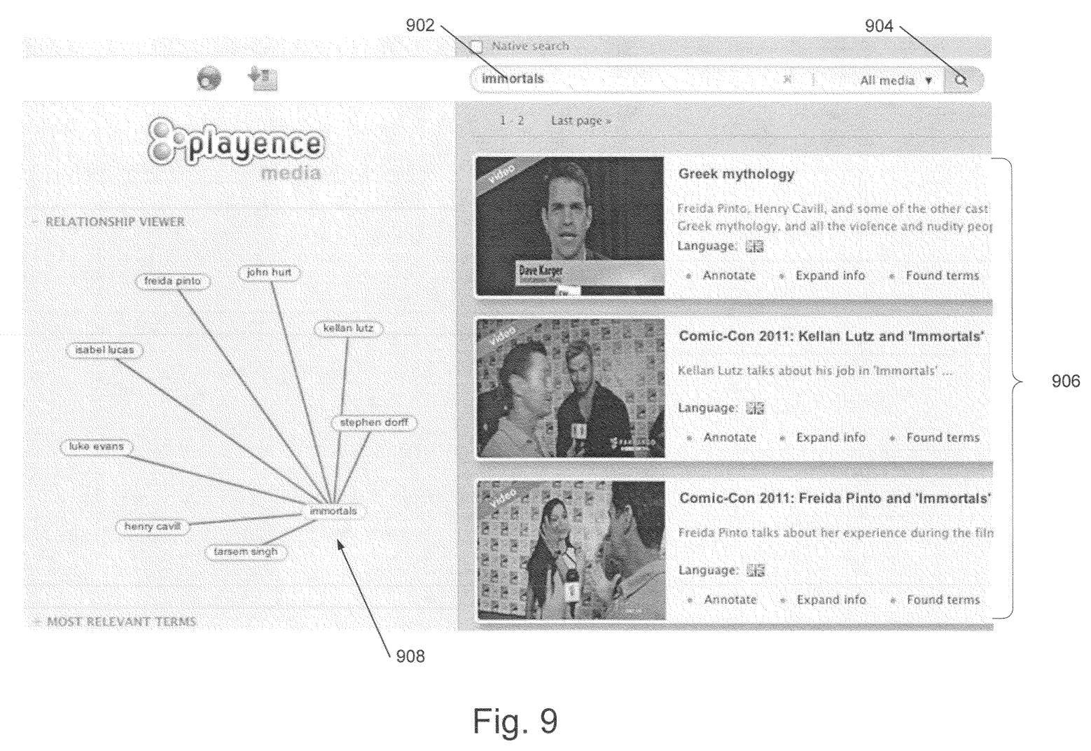

To provide further illustration of an implementation of the present system, FIG. 9 is a portion of screenshot showing an example user interface after the execution of an initial query where no additional restriction terms have been selected. As illustrated, a user has entered a natural language query into input box 902. The user has then activated search button 904 causing the natural language query to be executed against a particular knowledge base. That query has generated a set of results, at least a portion of which are displayed in region 906. As shown in FIG. 9, each result includes an image depicting at least a portion of a document associated with the result, as well as some text describing the result item. In accordance with steps 414 and 416 of the method of FIG. 4, the result set as well as the original query have been analyzed to generate a graph depicting terms present within the results and the query that are also present within the relevant knowledge model. Those identified terms are then displayed in graph 908, which depicts the identified terms as well as their interrelationships (indicated by lines in FIG. 9, though any other approach for depicting the interrelationships could be utilized).

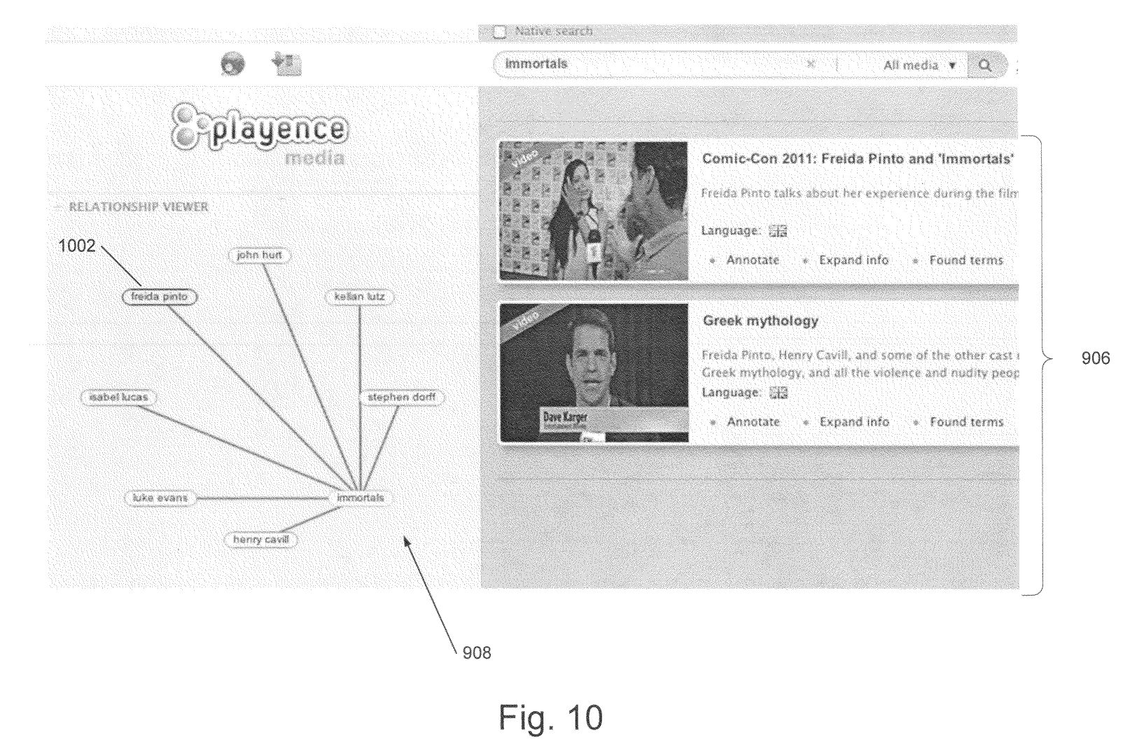

In accordance with the present disclosure, the user may select one or more terms from the graph 908 in order to further restrict or filter the result set. Accordingly, FIG. 10 is a portion of screenshot showing an example user interface after the execution of an initial query where one or more restriction terms have been selected. In FIG. 10, the term “freida pinto” 1002 has been selected in graph 908. In one implementation, the user may click upon the terms in order to the select the terms. Once a term from graph 908 is selected, the query is re-executed where the selected term is ANDED with the original natural language. Accordingly, the results of the search, once re-executed, will only include items that satisfy the requirements of both the original natural language query, as well as the selected term from graph 908. Consequently, as illustrated in FIG. 10, the result listing 906 includes fewer items as it is only a subset of the original result set that satisfies the original query, but also include the selected term 1002.

As a non-limiting example, the steps described above (and all methods described herein) may be performed by any central processing unit (CPU) or processor in a computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

Although the present invention has been described with respect to preferred embodiment(s), any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. An information retrieval system, comprising:
a knowledge model database configured to store a knowledge model for a knowledge domain, the knowledge model defining a plurality of entities and interrelationships between one or more of the plurality of entities;
a knowledge base identifying a plurality of items, each of the plurality of items being associated with at least one annotation identifying at one of the entities in the knowledge model; and
a query processing server configured to:
receive a natural language query from a client computer using a computer network,
execute a first query against the knowledge base using the natural language query to generate a first set of results, the first set of results identifying a first set of items in the knowledge base,
analyze the first set of results and the natural language query to identify a plurality of terms,
generate a graph of one or more of the entities in the knowledge model database using the plurality of terms,
transmit the graph to the client computer,
receive, from the client computer, a selection of at least one of the entities in the graph,
execute a second query against the knowledge base using the natural language query and the selected at least one of the entities in the graph to generate a second set of results, the second set of results identifying a second set of items in the knowledge base, and
transmit the second set of results to the client computer.

2. The system of claim 1, wherein the graph depicts a relationship between the one or more of the entities in the knowledge model database.

3. The system of claim 1, wherein the query processing server is configured to:
analyze the natural language query using named entity recognition.

4. The system of claim 1, wherein the knowledge model database is configured as a triplestore.

5. The system of claim 1, wherein the second set of results has fewer items than the first set of results.

6. The system of claim 1, wherein the second set of results includes a plurality of documents.

7. The system of claim 1, wherein analyzing the first set of results includes retrieving an annotation associated with at least one item of the first set of results.

8. A method for information retrieval, the method comprising:
receiving, from a client computer, a natural language query using a computer network;
executing a first query against a knowledge base using the natural language query to generate a first set of results, the knowledge base identifying a plurality of items, each of the plurality of items being associated with at least one annotation identifying at one of a plurality of entities in a knowledge model, the knowledge model defining a plurality of entities and interrelationships between one or more of the plurality of entities for a knowledge domain, the first set of results identifying a first set of items in the knowledge base;
analyzing the first set of results and the natural language query to identify a plurality of terms;
generating a graph of one or more of the entities in the knowledge model database using the plurality of terms;
transmitting the graph to the client computer;
receiving, from the client computer, a selection of at least one of the entities in the graph;
executing a second query against the knowledge base using the natural language query and the selected at least one of the entities in the graph to generate a second set of results, the second set of results identifying a second set of items in the knowledge base; and
transmitting the second set of results to the client computer.

9. The method of claim 8, wherein the graph depicts a relationship between the one or more of the entities in the knowledge model database.

10. The method of claim 8, including analyzing the natural language query using named entity recognition.

11. The method of claim 8, wherein the knowledge model database is configured as a triplestore.

12. The method of claim 8, wherein the second set of results has fewer items than the first set of results.

13. The method of claim 8, wherein the second set of results includes a plurality of documents.

14. The method of claim 8, wherein analyzing the first set of results includes retrieving an annotation associated with at least one item of the first set of results.

15. A non-transitory computer-readable medium containing instructions that, when executed by a processor, cause the processor to perform the steps of:
receiving, from a client computer, a natural language query using a computer network;
executing a first query against a knowledge base using the natural language query to generate a first set of results, the knowledge base identifying a plurality of items, each of the plurality of items being associated with at least one annotation identifying at one of a plurality of entities in a knowledge model, the knowledge model defining a plurality of entities and interrelationships between one or more of the plurality of entities for a knowledge domain, the first set of results identifying a first set of items in the knowledge base;
analyzing the first set of results and the natural language query to identify a plurality of terms;
generating a graph of one or more of the entities in the knowledge model database using the plurality of terms;
transmitting the graph to the client computer;
receiving, from the client computer, a selection of at least one of the entities in the graph;
executing a second query against the knowledge base using the natural language query and the selected at least one of the entities in the graph to generate a second set of results, the second set of results identifying a second set of items in the knowledge base; and
transmitting the second set of results to the client computer.

16. The medium of claim 15, wherein the graph depicts a relationship between the one or more of the entities in the knowledge model database.

17. The medium of claim 15, including instructions that, when executed by a processor, cause the processor to perform the steps of:
analyzing the natural language query using named entity recognition.

18. The medium of claim 15, wherein the knowledge model database is configured as a triplestore.

19. The medium of claim 15, wherein the second set of results has fewer items than the first set of results.

20. The medium of claim 15, wherein the second set of results includes a plurality of documents.
